(19) United States
(12) Patent Application Publication
(10) Pub. No.: US 2002/0194795 A1
(43) Pub. Date: Dec. 26, 2002

(54) Complete system of plastic or polyvinylchloride (PVC) components used for the construction of above ground decks or balconies

(76) Inventor: Paul Fredrick Spite, Warsaw, IN (US)

Correspondence Address: PAUL FREDRICK SPITE, 2319 E. 400 S., WARSAW, IN, 46580, US

(21) Appl. No.: 09/862,786

(22) Filed: May 21, 2001

(51) Int. Cl. E04H 1/00; E04H 3/00; E04H 5/00; E04H 9/00; E04H 14/00; E06B 3/54; E04B 9/00; E04B 2/30

(52) U.S. Cl. 52/79.1; 52/483.1; 52/480; 52/309.1

(57) ABSTRACT

An entire decking system of PVC extrusions and molded plastic fasteners centered around utilizing structural “T” profiles which incorporate diagonal web elements in a truss configuration and eliminate the need for joist support. The system being entirely of plastic eliminates differential movement in thermal expansion and contraction caused by dissimilar material use between components. The system is capable and intended to be installed rapidly, above grade, and without the use of foundations. Also incorporated in the system design are railings which mount directly into the fascia members of the deck, eliminating the need for railing posts and the attendant fastening difficulties presented by these.

### CROSS REFERENCE TO RELATED APPLICATIONS

Related decking applications are:

U.S. Patent Documents

| | | |
|---|---|---|
| 3,881,984 | 5/1975 | Soda, et al |
| 4,045,603 | 8/1977 | Smith |
| 4,602,765 | 7/1986 | Loper |
| 4,889,669 | 12/1989 | Suzuki |
| 5,009,045 | 4/1991 | Yoder |
| 5,048,448 | 9/1991 | Yoder |
| 5,078,367 | 1/1992 | Simpson |
| 5,412,915 | 5/1995 | Johnson |
| 5,613,339 | 3/1997 | Pollock |
| 5,647,184 | 7/1997 | Davis |
| 5,758,467 | 6/1998 | Snear, et al |
| 5,713,165 | 2/1998 | Erwin |
| 6,044,598 | 4/2000 | Elsasser, et al |

Related truss web applications are:

U.S. Patent Documents

| | | |
|---|---|---|
| 2,881,304 | 4/1959 | Dobson, et al |
| 6,080,495 | 6/2000 | Wright |

Related plastic fastener applications are:

U.S. Patent Documents

| | | |
|---|---|---|
| 3,080,630 | 3/1963 | Paliotta |
| 5,987,719 | 11/1999 | Cooper |

### STATEMENT REGARDING FEDERALLY SPONSERED RESEARCH OR DEVELOPMENT

Not Applicable

### REFERENCE TO A MICROFICHE APPENDIX

Not Applicable

### BACKGROUND OF THE INVENTION

In the field of building products, exterior decks and balconies are becoming increasingly popular in both residential and commercial applications. These decks and balconies provide space for a wide variety of outdoor and leisure activities. As family time becomes more restricted and therefore more valuable, attention has recently turned to the use of materials that are maintenance free. PVC extrusions and plastic composition decking members have been developed for use on top of wooden framing members, which are in turn supported by wooden beams, held up by wooden posts set in the ground or upon foundations. Railings, of either PVC or wood, can then be mounted on the surface of the decking.

U.S. Pat. No. 3,881,984 describes the creation of plastic composition decking through the foaming and extrusion of resin strands. This PVC lumber was intended to be fastened onto wood framing. U.S. Pat. No. 4,045,603 introduces the concept of using multiple layers, bonded to a core extrusion, to add strength to the product. U.S. Pat. No. 4,602,765 introduces the idea of an extrusion with an outer shell and inner core, capable of being routed and assembled as fencing. U.S. Pat. No. 4,889,669 describes the concept of co-extrusion to obtain a product with multiple layers in one continuous operation. U.S. Pat. No. 5,009,045 is of special interest with its introduction of horizontal surface scoring to increase traction and reduce slipping in adverse weather. Without a method to reduce the build-up of water, ice simply builds up to the top of the scoring and defeats the purpose, but the intent was there. In this same patent, the use of diagonal web members is shown, but only to a small degree and for the purpose of reducing the span of the bearing surface. U.S. Pat. No. 5,048,448 introduces a multi-part, snap together decking plank for ease in installation, with the top portion providing the main support structure. U.S. Pat. No. 5,078,367 is an example of an integrated system of PVC components, in this case, for use in fending. U.S. Pat. No. 5,412,915 utilizes decking extrusions over a sub-structure, with the decking members held in relationship to one another by spacing pins, allowing lateral shifting. U.S. Pat. No. 5,613,339 revisits the idea of a multi-part, snap together decking plank, this time with the bottom portion acting as the primary structure. U.S. Pat. No. 5,647,184 revisits the idea of a diagonal face in a decking extrusion, this time for the purpose of increasing the surface area of the fastening surface. U.S. Pat. No. 5,758,467 incorporates a system of spacing built into the extrusion itself. U.S. Pat. No. 5,713,165 utilizes a hollow extrusion, then fills it with foam to add rigidity and a non-slip surface of paint with a grit additive. U.S. Pat. No. 6,044,598 again utilizes a two part snap together system with concealed internal fasteners. This system does allow the drainage of surface water between the decking members. It also incorporates tread strips in the upper cover.

In these earlier applications of the extrusion of plastic to form maintenance free decking members, several recurrent weaknesses seem to occur. The primary one is that the application of the products over wood framing creates a differential movement between the two materials due to thermal expansion and contraction. This then requires the use of elaborate clip systems to allow bypass movement while still holding the product down. A second weakness is found in the tendency for interlocking deck extrusions to collect water in the joints, which then turns to ice and expands. A third problem is found in the increasing number and thickness of internal ribs in an effort to bring structural bearing capability to what is essentially a hollow, flexible material. A final weakness is that to date, the current use of the material has mostly been to mimic the size and shape of the material it is replacing. Uittle effort seems to have been made to take advantage of the malleability of the PVC material itself.

The use of diagonal web elements as mentioned above has been used in other applications, notably in the design of wood trusses, but in few applications of plastic. In U.S. Pat. No. 2,881,304, a corrugated core panel is extruded, then adhered to outer flat panels to add stiffness to the composite panel while reducing weight. U.S. Pat. No. 6,080,495 does essentially the same thing, only the inner corrugation is curved rather than angular and the outer plies are doubled. These products seem designed to replace cardboard used in packaging with a water resistant version of the product. They also do not really utilize the strength of truss framing, which is the dispersion of point loads into the entire structure by making the chord members interdependent.

The use of specialized plastic fasteners for PVC deck systems has been explored, but deck systems to date seem to rely on metal fasteners in one form or another. This creates the situation where the deck material will far outlast the fasteners holding it in place. Plastic fasteners that have potential for use in decking can be found by looking in other fields. U.S. Pat. No. 3,080,630 depicts a plastic cuff link that snaps into place to create a lock through misalignment of the fastener with the hole through which it was inserted. U.S. Pat. No. 5,987,719 also creates a locking system through misalignment, this time with the creation of a clothes tag fastener. Either of these ideas can be adapted for use in fastening extrusions together.

### BRIEF SUMMARY OF THE INVENTION

Briefly described, the present invention is a system of extruded PVC decking components, which would make possible the rapid assembly of a deck or balcony, while solving some existing weaknesses of existing PVC decking systems and components.

At its core, the system utilizes a structural “T” decking member which incorporates the wood joist and PVC decking of typical existing applications into one extruded PVC member. Also incorporated into the design of this are diagonal internal webs which act in a truss configuration to strengthen the member and distribute point loads throughout the entire “T” structure by making each chord and web member interdependent. This same system is used in the fabrication of edge members which can stand alone or are also capable of supporting fascia members which are adapted to allow railings to be dropped into them. All members are slotted to allow the use of locking fasteners.

The design of these fascia members and the top rail of the railing is adapted for the drop in capability and specifically incorporates small internal ribs which hold aluminum inserts in place while allowing stiles to bypass the insert for additional rigidity.

Assisting in the ease of construction of decks and balconies using this system are sleeper and/or sled components to allow installation directly on leveled ground. If the system is installed off the ground, a PVC beam is used with PVC brackets to allow pinned connections to PVC posts and to connect the posts to a sled piece, if they are not installed in the ground.

Integral to the connections of all the components are a series of molded plastic fasteners. These allow locking and spacing at the same time and attach through slots or holes in the main components.

The objects of the design of this system of components were as follows. The system will make the complete assembly of a deck system possible in a very short time span and without foundations. The integration of the plank and joist portions into one component eliminates the need for joist fasteners and takes true advantage of the malleability of the medium of plastic. All of the components of the deck or balcony being comprised of plastic eliminates the problem of differential movement caused by the combination of dissimilar materials. It also eliminates any problems caused by different life spans of materials currently used together in PVC deck applications. The truss configuration of the components of each major extrusion will create true structural capabilities for the individual members. The integration of the railing support into the deck members eliminates the need for railing posts. Finally, water simply drains through the system, eliminating the build-up of ice.

### BRIEF DESCRIPTION OF THE SEVERAL VIEWS OF THE DRAWING

FIG. 1. shows, in cross section and isometric view, a representation of the elements of the entire deck system, as it would be assembled on sleepers on the ground.

FIG. 2. shows in cross section, a representation of the elements of the entire deck system, as it would be assembled on sleepers on the ground. This view shows the shorter of two rail supporting fascia pieces mounted parallel to the “T” and edge members.

FIG. 3. shows in cross section, a representation of the elements of the entire deck system, as it would be assembled on sleepers on the ground. This view shows the longer of two rail supporting fascia pieces mounted perpendicular to the “T” and edge members. This view also shows the use of the free mount sled piece under the sleeper for weight distribution.

FIG. 4. shows in cross section, a representation of the elements of the entire deck system, as it would be assembled on beams above the ground. This view shows the longer of two rail supporting fascia pieces mounted perpendicular to the “T” and edge members. This view also shows the use of the beam mounting bracket, connected to a post, connected to a sled plate mounting bracket, connected to a bracket mount sled plate for weight distribution.

FIG. 5. shows, using orthogonal projection views and an isometric view, an extruded PVC edge deck member, complete with fastener slots and diagonal cross scoring to increase traction.

FIG. 6. shows, using orthogonal projection views and an isometric view, an extruded PVC internal “T” deck member, complete with fastener slots and diagonal cross scoring to increase traction.

FIG. 7. shows in plan view, a molded threaded pin connector to be used in pinning together beams, posts, post mounting brackets and sled mounting brackets.

FIG. 8. shows, using orthogonal projection views and an isometric view, a molded offset fastener to be used in securing deck members together and deck members to the lower slots of parallel fascia members, while maintaining a spacing between them.

FIG. 9. shows, using orthogonal projection views and an isometric view, a molded extended offset fastener to be used in securing deck members to the upper slots of parallel fascia members when an aluminum stiffener is included in the fascia member, while maintaining a spacing between them.

FIG. 10. shows, using orthogonal projection views and an isometric view, a molded offset fastener with a spring clip molded to it, to be used in securing slotted deck members to the upper slots of a perpendicular fascia member, while maintaining a spacing between them.

FIG. 11. shows, using orthogonal projection views and an isometric view, a weight bearing aluminum insert with an offset locking key to be inserted in the lower slots and used in the support of fascia members mounted perpendicular to the deck members.

FIG. 12. shows, using orthogonal projection views and an isometric view, a PVC beam mounting bracket intended to cap over a post and wrap up two sides of a beam, pinned in place by threaded pin connectors. Turned over, it functions as a sled plate mounting bracket.

FIG. 13. shows, using orthogonal projection views and an isometric view, an extruded PVC bracket mount sled plate used below posts and columns for weight distribution. This view shows the use of a portion of post attached to the sled plate to assist in post alignment. An alternate idea would be to adhere a sled plate mounting bracket directly to the sled plate to accept the post for anchoring.

FIG. 14. shows, using orthogonal projection views and an isometric view, an extruded PVC free mount sled plate used below sleepers for weight distribution. This view shows the use of the plate as it would be used under a sleeper piece, without a portion of post attached to the sled plate.

FIG. 15. shows, using orthogonal projection views and an isometric view, a section of an extruded PVC beam with the top section free of diagonal bracing and notched to horizontally and vertically support the deck members.

FIG. 16. shows, using orthogonal projection views and an isometric view, a section of an extruded PVC sleeper with the top section free of diagonal bracing and notched to horizontally and vertically support the deck members.

FIG. 17. shows, using an isometric view, a section of an internal aluminum tube stiffener, routed to allow stiles to pass through it.

FIG. 18. shows, using orthogonal projection views and an isometric view, a section of extruded PVC fascia mounted perpendicular to deck framing members, routed for stile insertion, and slotted to receive offset and spring clip combination fasteners above and weight bearing aluminum inserts below. This fascia extrusion also incorporates internal ribs to hold the aluminum insert in place, while allowing stiles to pass through.

FIG. 19. shows, using orthogonal projection views and an isometric view, a section of extruded PVC top rail, with internal ribs to hold stiles in place and routed on the opposite face to receive stiles.

FIG. 20 shows, using an isometric view, an extruded PVC stile to be mounted into the extruded PVC deck fascia members and into extruded PVC top railing.

FIG. 21. shows, using orthogonal projection views and an isometric view, a section of extruded PVC fascia mounted parallel to deck framing members, routed for stile insertion and slotted to receive extended offset fasteners above and offset fasteners below. This fascia extrusion also incorporates internal ribs to hold the aluminum insert in place, while allowing stiles to pass through.

### DETAILED DESCRIPTION OF THE INVENTION

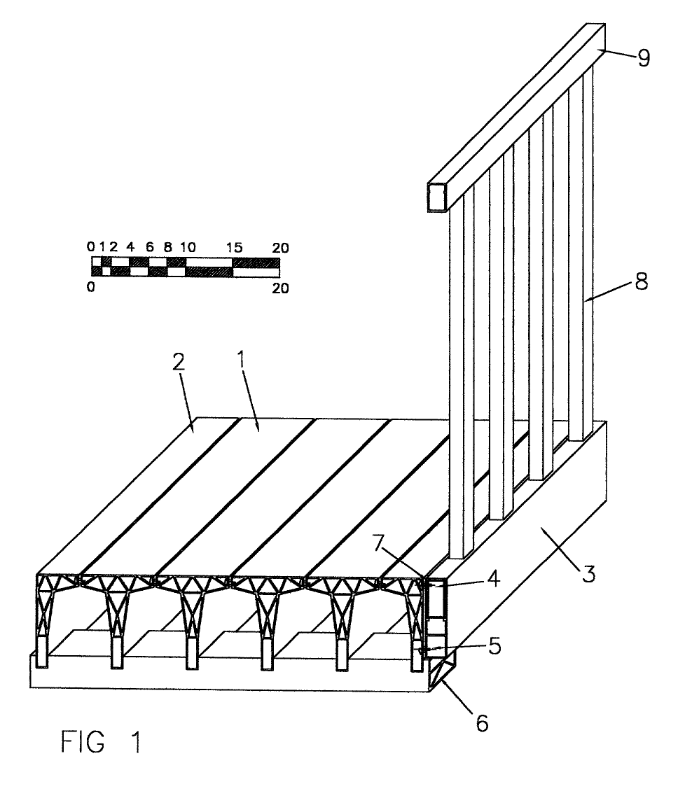

Referring now in detail to the drawings, FIG. 1 is a representation of the elements of the system, as assembled on sleepers on leveled ground. The “T” deck members (1) and the edge deck members (2) are set down into the slotted spaces on top of the sleeper (6). These act as bridging for the bottom of the deck members. The tops are fastened together using offset fasteners (5) which are inserted into one member slot, turned 90 degrees, inserted into the adjacent member slot, and turned another 90 degrees to lock both together. An aluminum insert routed for stiles and slotted for fasteners (7) is inserted into the parallel fascia member (3) before it is brought to the job site. Extended offset fasteners (4) are inserted into the upper slots of the edge deck member (2) and turned so that the tabs are horizontal. Offset fasteners (5) are then inserted into the lower slots of the parallel fascia member (3) and turned with tabs pointing down. These tabs are then inserted into corresponding slots in the edge deck member (2) and the fascia tipped up to allow the insertion of the extended offset fastener (4) tabs into the upper fascia slots. The central octagonal portion of the fastener is then turned 90 degrees to lock the parallel fascia member (3) in place. PVC stiles (8) are then inserted into and through the routed openings in the top of the parallel fascia member (3) and the aluminum insert (7) inside of it. These stiles are then capped by the ribbed top rail (9) by inserting the stiles (8) into it and up through the ribs inside.

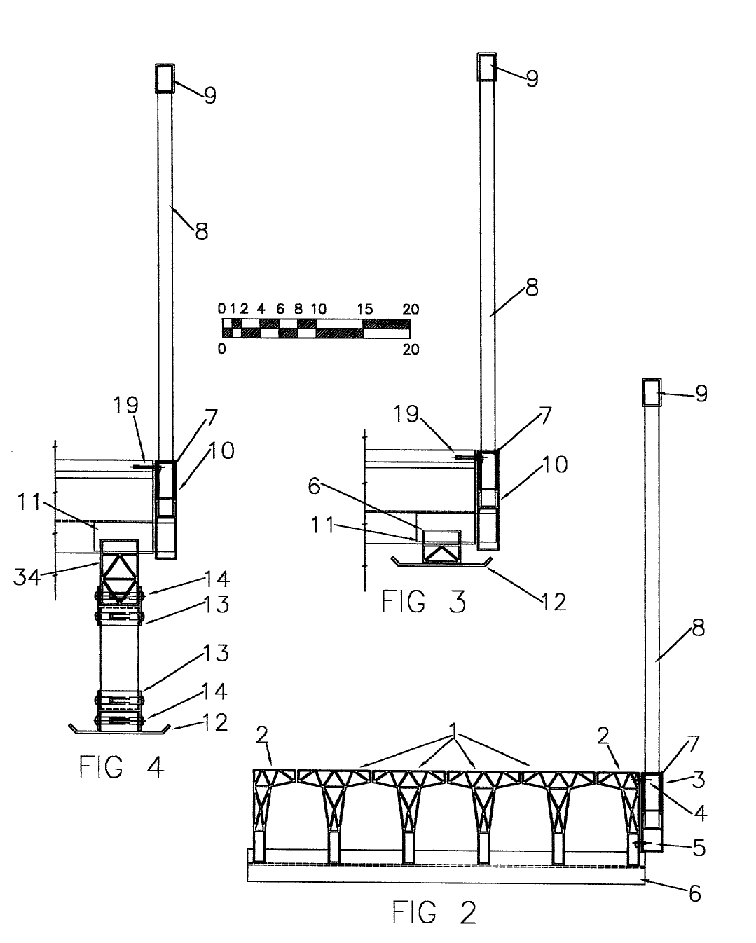

FIG. 2 represents the same configuration of system elements as FIG. 1, only they are shown only in section.

FIG. 3 shows the other edge view of the configuration on sleepers (6) on the ground. At this edge, the perpendicular fascia member (10) would be used. As before, the aluminum insert (7) would be inserted before the perpendicular fascia member (10) arrived on the site. Offset fasteners with spring clips (19) would be inserted into the perpendicular fascia member (10) with the clips oriented vertically. The weight bearing aluminum inserts would be mounted inside the lower portion of the “T” deck section (1) that is free of diagonal webs, with the offset locking key oriented up. Then, the lower slots in the perpendicular fascia member (10) would be set over and on the weight bearing aluminum inserts until the offset locking key was well up inside the perpendicular fascia member (10). Then, the fascia would be tipped up, allowing the spring clip on the upper fastener (19) to slide to each side of the upper side flanges of the “T” deck members (1) opposite it, until they snapped into place in the slots routed in the “T” deck members (1) for that purpose. From that point on, assembly and insertion of the railing components (8) (9) would continue as above. Also in FIG. 3 is shown the use of a bracket mounted sled plate (12) to further distribute the loading on the sleeper (6) down to the soil.

FIG. 4 shows the same use of the deck members, fascia pieces, and railing components. In this view, the sleeper is replaced by a structural beam (34), also notched in the upper portion where diagonal webbing is omitted, to act as support and as bridging. Wrapping the sides of this beam and extending below it is a mounting bracket (13) connected through the beam with threaded pin connectors (14). These threaded pin connectors (14) are also used to tie a PVC column extending up from below into the bottom section of the mounting bracket (13). This post, of whatever length, either terminates in the ground, on a foundation, or can be mounted into the top portion of an inverted mounting bracket (13) and pinned (14). This bracket is then mounted over a bracket mounted sled plate (12) and pinned (14) into place.

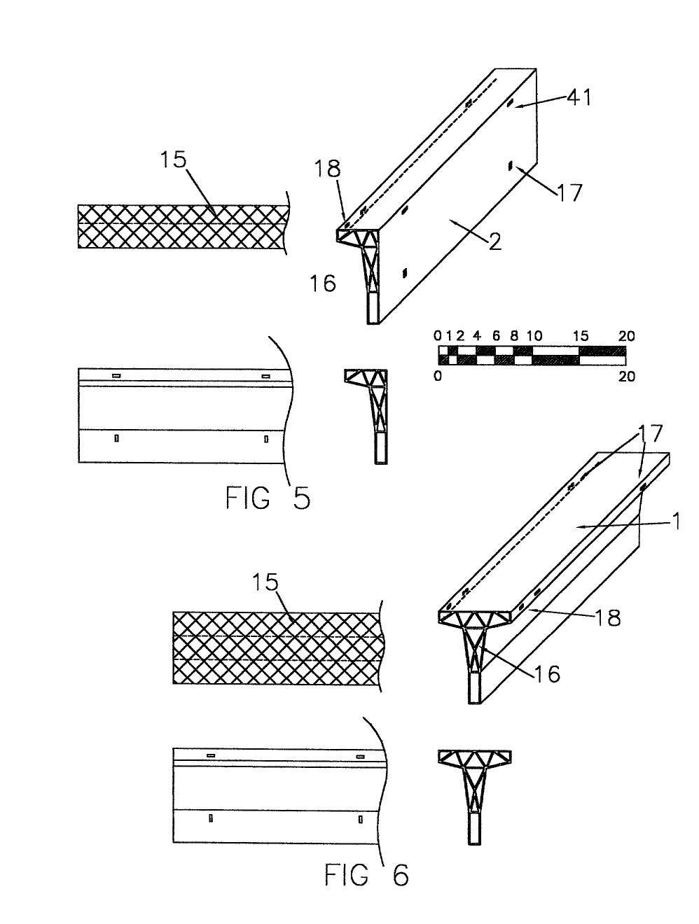

FIG. 5 is a more detailed representation of an edge deck member (2). This would be extruded (or co-extruded or tri-extruded) with internal web members (16) in a truss configuration to distribute point loads by making all the chords of the “truss” interdependent. The upper part of the exterior face would be slotted (41) to receive extended offset fasteners (4), while the lower face would be slotted (17) to receive the offset fasteners (5). On the inner face of the upper flange, a hole (18) would be routed to receive the spring clip portion of the offset fasteners with spring clips (19). The top surface would be scored diagonally (15) to increase traction, with the scoring continuing to and through the sides of the member to allow complete drainage.

FIG. 6 is a more detailed representation of an “T” deck member (1). This would be extruded, co-extruded, or tri-extruded with internal web members (16) in a truss configuration to distribute point loads by making all the chords of the “truss” interdependent. The sides of the upper flange would be routed (17) to receive offset fasteners (4), Also on each face of the upper flange, a hole (18) would be routed to receive the spring clip portion of the offset fasteners with spring clips (19). The top surface would be scored diagonally (15) to increase traction, with the scoring continuing to and through the sides of the member to allow complete drainage.

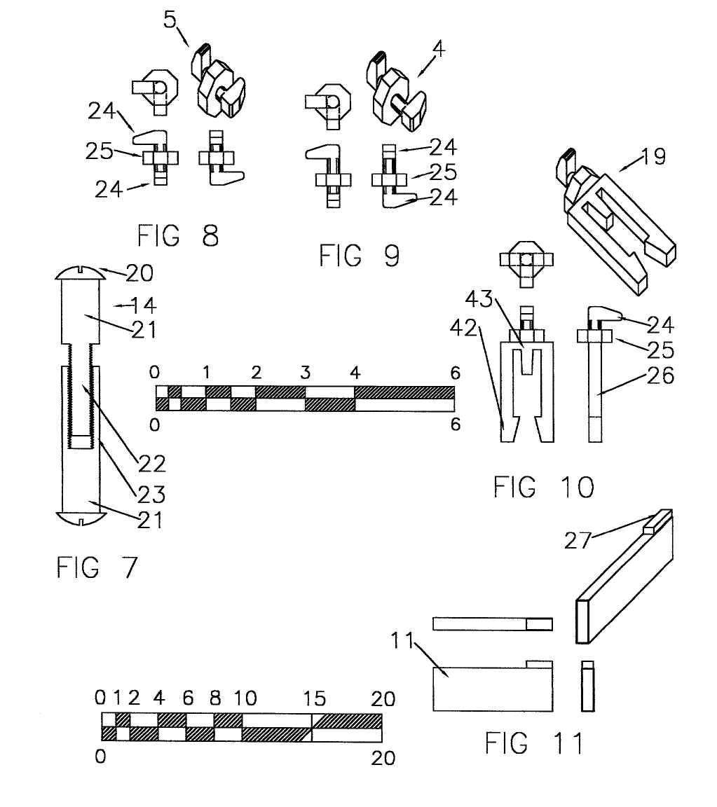

FIG. 7 is a diagram of a molded plastic threaded pin connector (14) to be used in pinning brackets and structural elements together. The main diameter (21) of the pin would be slightly smaller than the holes drilled through the parts it will pin together. The length would vary depending on the application. Both sides would have a slotted head (20) to facilitate turning. One side would have a threaded male extension (22). The other side would have a threaded female extension (23). The connection would be made and tightened as both sides were turned in opposition to one another.

FIGS. 8 and 9 are detailed representations of a molded plastic offset connector (5) and an extended offset connector (4). The connection is made by inserting the tab (24) on one side through a horizontal slot in the side of one deck or fascia member, then turning the connector 90 degrees. This will bring the other tab (24) into a horizontal position, allowing it to also be inserted into a horizontal slot in the adjacent deck or fascia member. When turned again another 90 degrees, this will lock both members together. The octagonal “nut” (25) in the center acts both as a spacer and as a way to turn the fastener the second time. The extended version of the connector in FIG. 9 is to allow for the extra wall thickness when one member has an aluminum insert inside.

FIG. 10 is a detailed representation of a molded plastic offset connector with integral spring clips (11). The connection is made by inserting the tab (24) on one side through a horizontal slot in the side of a fascia member, then turning the connector 90 degrees. This will bring the spring dip on the other side into a vertical orientation. Then, when the spring clip (26) is inserted on either side of the walls of adjacent deck members and pushed forward, the tabs on the end (42) will snap into and lock in the holes routed in the sides of the deck members for that purpose. The small tang in the center (43) acts as a spacer between deck members and keeps tension on the clip. As before, the octagonal nut (25) acts as a spacer between the deck members and the fascia.

FIG. 11 is a detailed representation of a weight bearing aluminum insert (11). This insert would go into the lowest portion of the deck members (1) (2), left void of diagonal webbing for that purpose. They would be inserted leaving the end with the locking key (7) oriented vertically. The perpendicular fascia member would then dropped over this insert, locked in place by the key which would rest inside of the fascia.

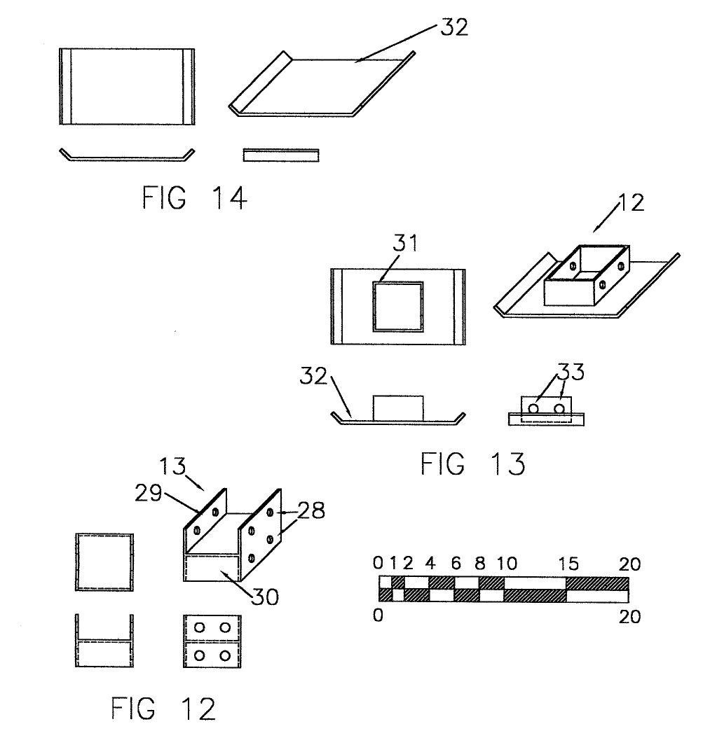

FIG. 12 is a detailed representation of a mounting bracket (13) for the purpose of connecting a PVC post to a beam or a bracket mounted sled plate. This is dimensioned to fit over various size columns, with the upper portion of the bracket having two opposing walls (29). The lower portion has all four walls (30) and would act as a cap or a base for a column. On opposing sides, two holes would be drilled on the upper and on the lower portions for use with the threaded pin connectors.

FIG. 13 is a detailed representation of a bracket mounted sled plate (12). This extruded plastic sled plate (32) would vary in size depending on soil conditions, but in any case would act to transfer and distribute the load from the post or sleeper to the soil. The tube section (31) adhered to the plate would slide up inside the mounting bracket, to be pinned in place by threaded pin connectors through the holes (33) in the sides of the tube section.

FIG. 14 is a detailed representation of a sled plate (32). This extruded PVC sled plate would vary in size depending on soil conditions, but in any case would act to transfer and distribute the load from the sleeper to the soil.

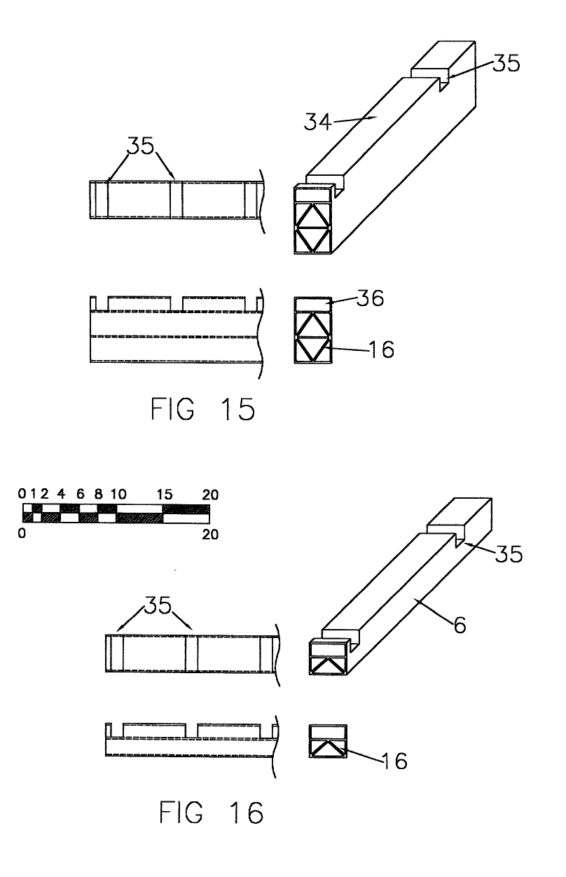

FIG. 15 is a detailed representation of a structural beam (34). This extruded PVC beam would vary in size and depth according to the load imposed upon it. The top section of the beam (36) would be void of diagonal web members to allow notching (35) into which deck members would be placed and be laterally braced. The remaining lower portion uses diagonal web members (16) and triangulation to strengthen the member and distribute the load to interdependent members.

FIG. 16 is a detailed representation of an extruded PVC sleeper (6) member, placed over level ground, upon which deck members will be placed. The top section of the sleeper is void of diagonal web members to allow notching (35) into which deck members would be placed and be laterally braced. The remaining lower portion uses diagonal web members (16) and triangulation to strengthen the member and distribute the load to interdependent members.

FIG. 17 is a detailed representation of an aluminum insert (7) to be insert into fascia members to provide greater support for the drop-in railing system. Openings for stiles (37) will be routed into the top and bottom surfaces of the insert.

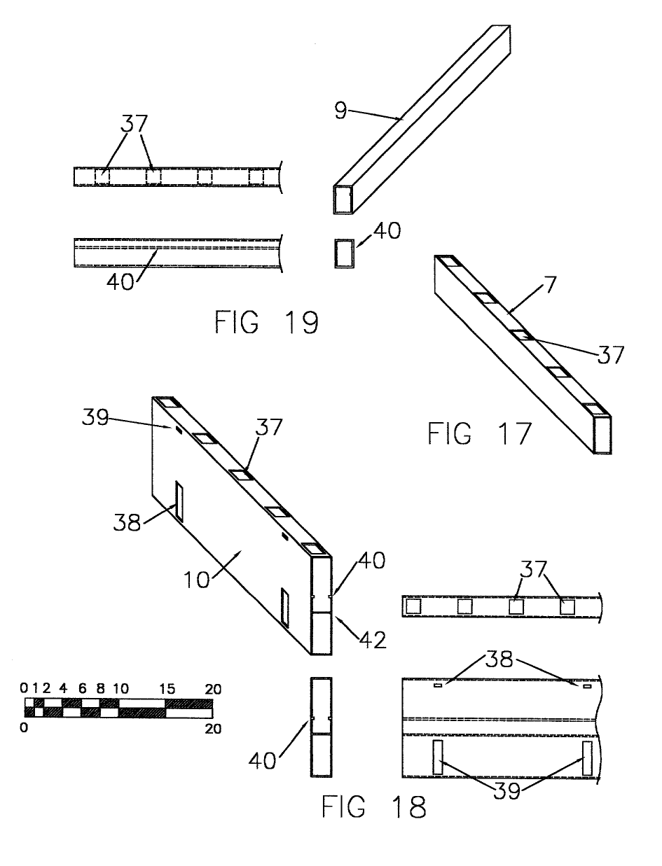

FIG. 18 is a detailed representation of a perpendicular fascia member (10). This extruded PVC member will be routed on the upper part of the inner face (39) to receive extended offset fasteners (4). It will also be routed on the lower part of the inner face (38) to receive the insertion of weight bearing aluminum inserts (11). Integral ribs (40) will be extruded into the fascia profile to hold the aluminum insert (7) in place, but allow the stiles to pass. Openings for the stiles (37) will be routed into the top surface to receive the stiles. An integral web (42) will hold the bottom of the stiles in position.

FIG. 19 is a more detailed representation of an extruded PVC top rail (9). This will be routed on the bottom (37) to accept the insertion of stiles. Integrated into the extrusion will also be ribs (40) to grip the sides of the stiles and prevent lateral shifting of the rail.

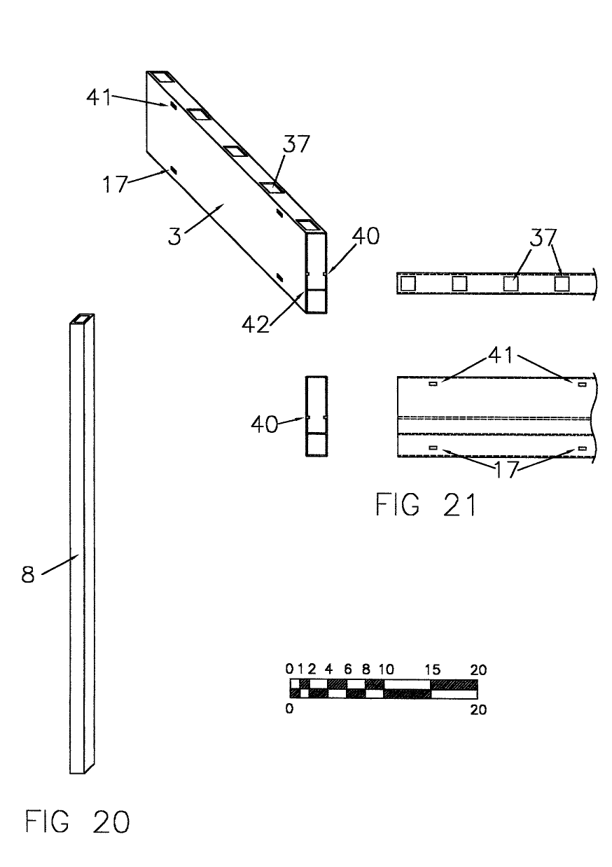

FIG. 20 is a more detailed representation of a vertical extruded PVC stile (8) used in the railing system.

FIG. 21 is a detailed representation of a parallel fascia member (3). This extruded PVC member will be routed on the upper part of the inner face (41) to receive extended offset fasteners (4). It will also be routed on the lower part of the inner face (17) to receive the offset fasteners (5). Integral ribs (40) will be extruded into the fascia profile to hold the aluminum insert (7) in place, but allow the stiles to pass. Openings for the stiles (37) will be routed into the top surface to receive the stiles. An integral web (42) will hold the bottom of the stiles in position.

While the inventions have been disclosed in preferred forms, it will be apparent to those knowledgeable in the extrusion and use of PVC profiles that many additions, deletions, and modifications may be made therein without departing from the spirit and scope of the invention as set forth in the following claims.

What I claim as my invention is:

1. A complete system of plastic or polyvinylchloride (PVC) components used for the construction of above ground decks or balconies, composed of the following elements and used in the following manner:
a. In the case of either a deck being installed or a balcony being installed, the ground below will be leveled.
b. If a balcony or an above grade deck is to be built, PVC posts can either be installed on existing foundations, set into the ground below frost depth, or set above grade on PVC bracket mounted sled plates, pinned together by threaded plastic pin connectors.
c. If a balcony is to be built, PVC mounting brackets are then installed on top of the posts to receive an extruded PVC beam, notched for deck members, with all components connected to the bracket by threaded plastic pin connectors.
d. If a balcony is to be built, the notched extruded PVC beams are then set onto the brackets mounted on the posts, pinned in placed by threaded pin connectors, and laid out to the required dimensions.
e. If an on grade deck is to be built, PVC sled plates are set on the ground to help distribute the load on the sleeper members.
f. Extruded PVC sleeper members, notched for deck members, are then laid out to the size required for the on grade deck.
g. The lower portion of two extruded PVC composite edge deck members and as many extruded PVC composite intermediate “T” deck members as needed would be placed into the notches of the sleeper member or beam member to comprise both the framing and surface of the deck or balcony.
h. These extruded PVC composite deck members would then be connected together and spaced apart to allow drainage with the use of using molded plastic offset fasteners, inserted through opposing slots, and rotated to lock them in place.
i. If a railing is desired, extruded PVC parallel fascia members with aluminum or other structural inserts would then be installed on the sides of the extruded PVC composite edge deck members, using molded plastic offset connectors and molded plastic extended offset connectors.
j. If a railing is desired or not, extruded PVC perpendicular fascia members with or without aluminum or other structural inserts would then be installed on the faces of the extruded PVC composite deck members, using weight bearing aluminum inserts and using molded plastic offset fasteners with spring clips.
k. Extruded PVC stiles for railings would then be inserted into holes routed into the fascia members for that purpose.
l. A ribbed extruded PVC top cap would then be installed over the top of the stiles, completing the installation.

2. The use of all plastic or PVC components for the deck/balcony system in claim 1, to eliminate the problems of differential movement caused by the thermal expansion and contraction of different materials normally combined in deck or balcony construction.

3. The integration of polyvinylchloride (PVC) decking extrusions and the joist structure which normally supports them into one extruded “T” or edge decking profile, to form the extruded PVC composite deck members used in claim 1.

4. The use of extruded diagonal webbing members in the PVC extrusions used in claim 1, fabricated in a truss configuration to add strength through the use of triangulation and to distribute point loads by making each member or web of the “T” or edge decking profile structurally interdependent.

5. The use of horizontal beam or sleeper members in claim 1, which have one web-free compartment, notched to support decking members in a horizontal bridging role, while the main compartment upon which the members bear structurally, also utilizing diagonal webs in the extrusion process to create strength through triangulation and structural interdependence, remains intact.

6. The use of notched extruded, or even solid, PVC sleepers in claim 1, directly on level ground or sand, to permit the rapid layout and assembly of an entire deck system utilizing molded PVC composite decking members.

7. The creation of molded plastic fastener/spacer combinations, described as offset fasteners, and extended offset fasteners, inserted through matching slots in the surfaces of extrusions to lock the extrusions in claim 1 together, applicable from the top surface, while maintaining spacing between the extrusions.

8. The combined use of a PVC extrusion in claim 1 as a decorative fascia and as a structural unit to mount a railing system in or upon.

9. The incorporation of partial webs into extruded PVC profiles, including fascia members such as those used in claim 1, to guide and contain the insertion of routed structural inserts such as aluminum tubes, while allowing the passage of other profiles such as stiles past and through the insert.

10. The incorporation of partial webs into extruded PVC profiles, including rail members such as those used in claim 1, to prevent lateral rotation at the top of the rail sections after the insertion of stiles or other extruded PVC profiles.

11. The use of molded plastic spring clip fasteners, described in claim 1 as offset fasteners with spring clips, to snap into routed openings on the inside surfaces of adjacent profile walls, holding them together, while spacing them apart.

12. The use in claim 1 of weight bearing aluminum inserts with a locking key, inserted horizontally into extrusion voids of structural members, to support extruded routed fascia members or other PVC extrusions mounted perpendicular to the main structural members.

13. The use of a PVC mounting bracket in claim 1 to facilitate the connection of a post to a sleeper, to a beam, or to a modified sled base plate.

14. The use of a PVC sled base in claim 1, below sleepers or below posts, to distribute and transfer weight directly to the ground, utilized in the assembly of a deck package above ground.

15. The use of molded plastic threaded pin connectors in claim 1 to pin different PVC extrusions together, adjustable enough to hold them in specific relation to one another, yet allowing pin rotation when desired and used singly.
